(19) United States
(12) Patent Application Publication
(10) Pub. No.: US 2013/0189987 A1
(43) Pub. Date: Jul. 25, 2013

(54) USER EQUIPMENT CENTRIC MECHANISM FOR ENABLING 2G/3G PREFERRED CAMPING

(71) Applicant: QUALCOMM Incorporated, San Diego, CA (US)

(72) Inventors: Thomas KLINGENBRUNN, San Diego, CA (US); Vieri VANGHI, Firenze (IT); Bhupesh M. UMATT, San Diego, CA (US)

(73) Assignee: QUALCOMM INCORPORATED, San Diego, CA (US)

(21) Appl. No.: 13/748,532

(22) Filed: Jan. 23, 2013

Related U.S. Application Data
(60) Provisional application No. 61/589,822, filed on Jan. 23, 2012.

(51) Int. Cl. H04W 36/16

(52) U.S. Cl. CPC H04W 36/165
USPC 455/436

(57) ABSTRACT

A method, an apparatus, and a computer program product for wireless communication are provided. The apparatus receives, at a user equipment, broadcast system information including one or more reselection priorities defined by a network operator for UE operation, each of the reselection priorities identifies a priority for one or more of a RAT and a RAN. The apparatus determines the availability of a first radio access network (RAN) operated using a first radio access technology (RAT) while camped in idle mode on a second RAN using a second RAT. The apparatus initiates a reselection procedure targeting the first RAN regardless of the reselection priorities.

### CROSS-REFERENCE TO RELATED APPLICATION(S)

This application claims the benefit of U.S. Provisional Application Ser. No. 61/589,822, entitled “USER EQUIPMENT CENTRIC MECHANISM FOR ENABLING 2G/3G PREFERRED CAMPING” and filed on Jan. 23, 2012, which is expressly incorporated by reference herein in its entirety.

### BACKGROUND

1. Field

The present disclosure relates generally to communication systems, and more particularly, to a user equipment (UE) centric mechanism to enable the UE to initiate reselection to a first radio access network (RAN) using a first radio access technology (RAT) regardless of the reselection priorities received from a network. For example, the present disclosure relates to a UE centric mechanism that enables 2G/3G preferred camping for Long Term Evolution (LTE) Circuit Switched Fall Back (CSFB) capable devices with a service based escalation to LTE for data transfer.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

Certain operational characteristics, policies and procedures to be followed by a UE connected to a RAN may be specified by a network operator. The operational characteristics, policies and procedures are typically communicated to the UE in system information blocks (SIBs). The operator may specify mobility procedures that govern network reselections, handover, and access preferences. A network operator may set priorities for cell acquisition that determine the priorities of supported RATs accessible by the UE. For example, a network operator may set priorities that cause a UE to camp on a preferred network when the UE is idle. In many instances, LTE is the preferred network for LTE-capable UE camping to enable the UE to avail of enhanced data services. However, the UE may be required to fallback to a circuit-switched network to receive or make a call, and the fallback process may create delays in call placement or reception.

For example, in an LTE network where CFSB is used to provide voice services, a voice call is setup by first moving the phone or device from the LTE network to a 2G or 3G network. The call is set up using typical circuit switched (CS) call set up procedure. This increases call set up delay. A network based approach to resolving this problem requires expensive and time consuming network upgrades, something that network operators would like to avoid. Therefore, there is a need in the art for a UE based approach to reducing such call set up delay that avoids network upgrades.

### SUMMARY

Aspects presented herein overcome the above described problems and unmet needs by providing a UE based approach to network reselection that enable the UE to initiate reselection to a first RAN using a first RAT regardless of the reselection priorities received from a network. This enables the UE to initiate reselection to a RAN having a lower data rate, such as 2G or 3G, for LTE CSFB capable devices regardless of whether the reselection priorities received from the network.

In an aspect of the disclosure, a method, a computer program product, and an apparatus are provided. The apparatus receives, at a user equipment, broadcast system information including one or more reselection priorities defined by a network operator for UE operation, each of the reselection priorities identifies a priority for one or more of a RAT and a RAN. The apparatus determines the availability of a first RAN operated using a first RAT while camped in idle mode on a second RAN using a second RAT. The apparatus initiates a reselection procedure targeting the first RAN regardless of the reselection priorities.

This enables a UE to obtain better voice call setup performance in idle mode, while providing a good user experience by moving to, e.g., 4G LTE as soon as a user initiates a data transfer

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 illustrates aspects of a system employing 2G/3G preferred camping.

FIG. 8 is a flow chart of aspects of a method of wireless communication.

FIG. 9 illustrates aspects of a UE transition from UMTS to LTE back to UMTS.

FIG. 10 illustrates aspects of a UE transition with CSFB in a connected state.

FIG. 11 illustrates aspects of a UE transition with CSFB in a connected state.

FIG. 12 is a flow chart of a method of wireless communication.

FIG. 13 is a conceptual data flow diagram illustrating the data flow between different modules/means/components in an exemplary apparatus.

FIG. 14 is a diagram illustrating an example of a hardware implementation for an apparatus employing a processing system.

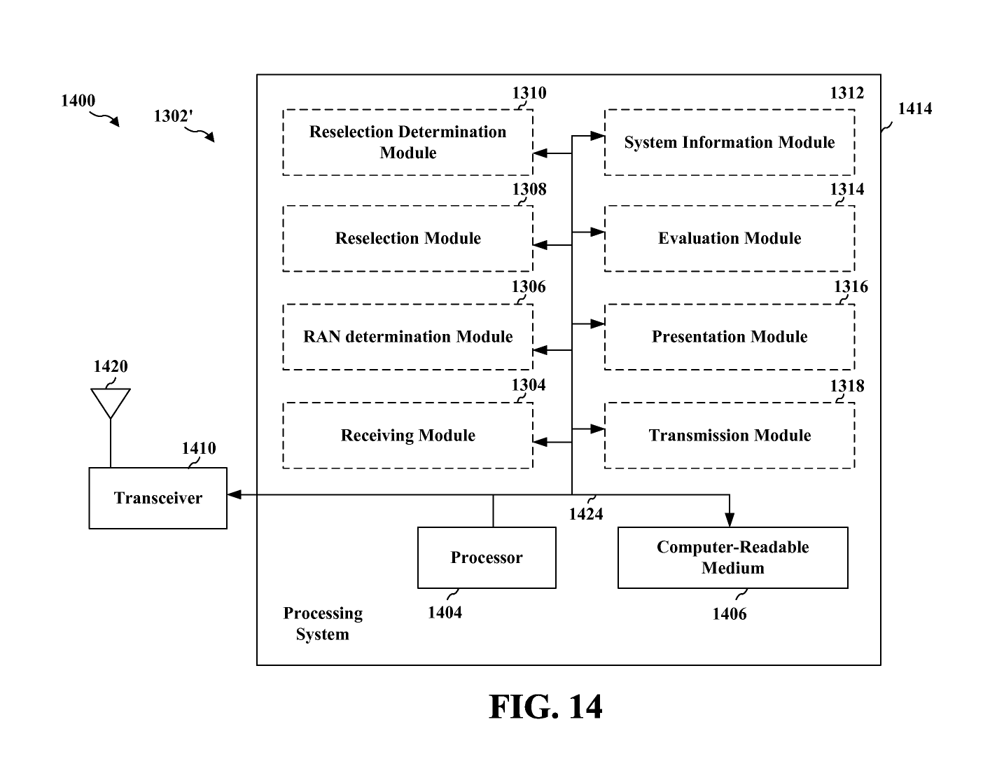

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

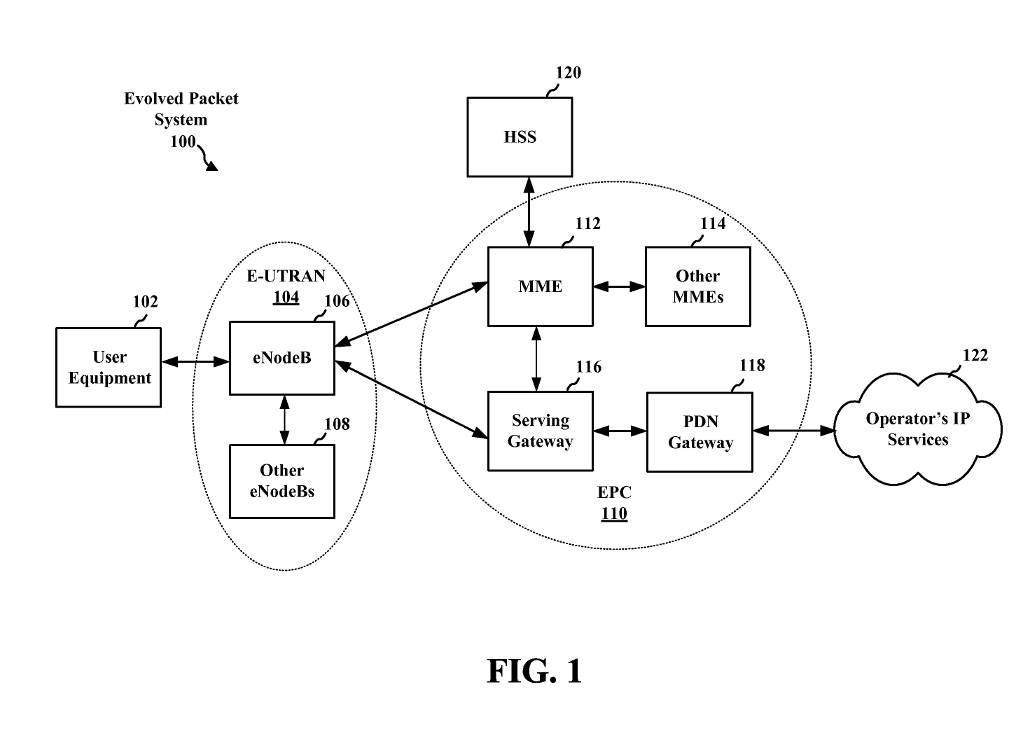

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

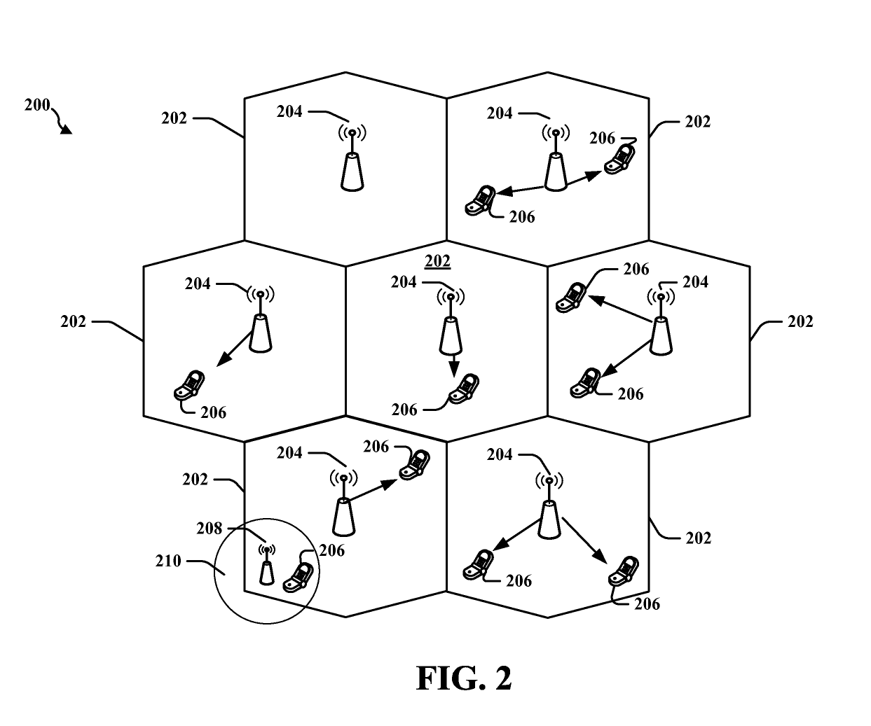

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

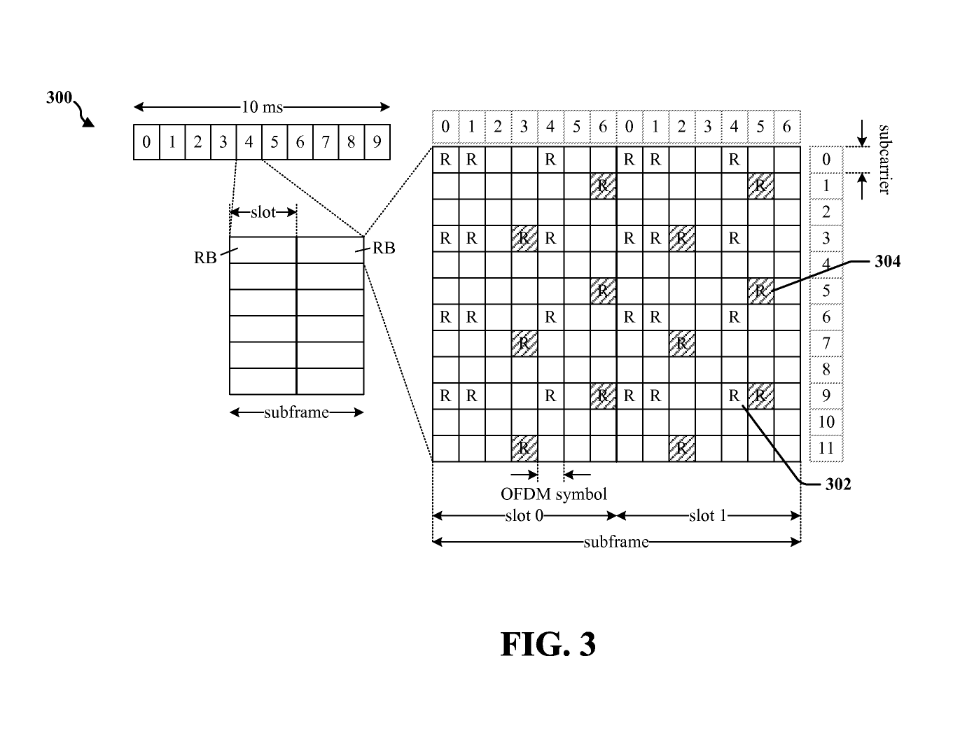

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

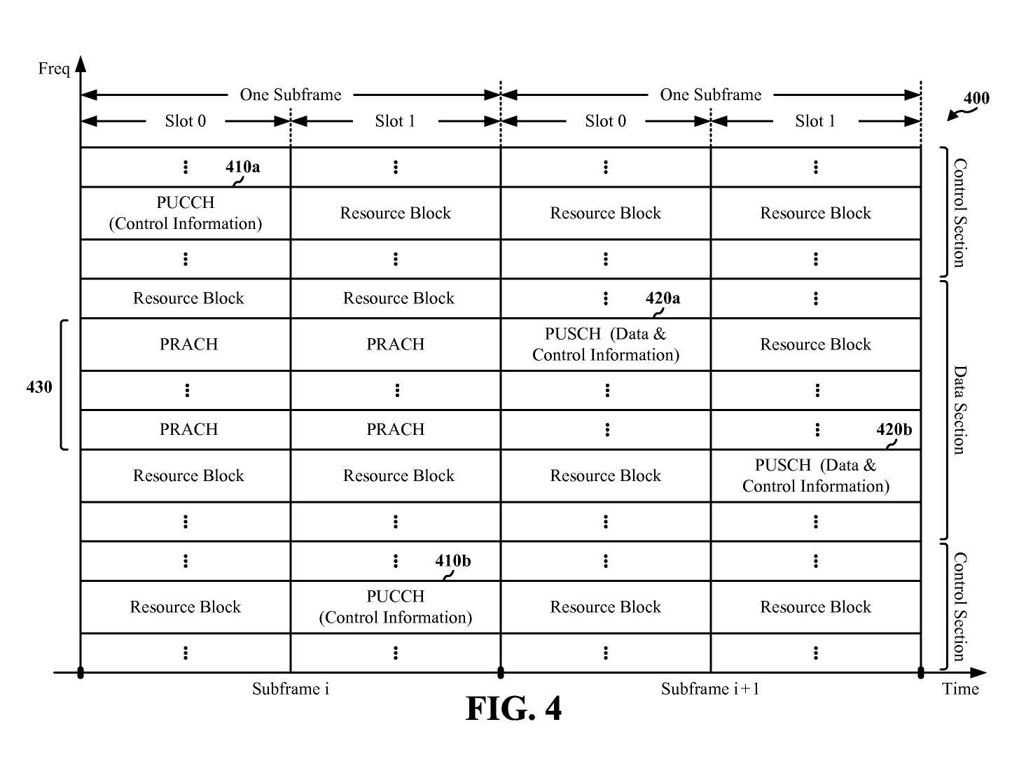

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

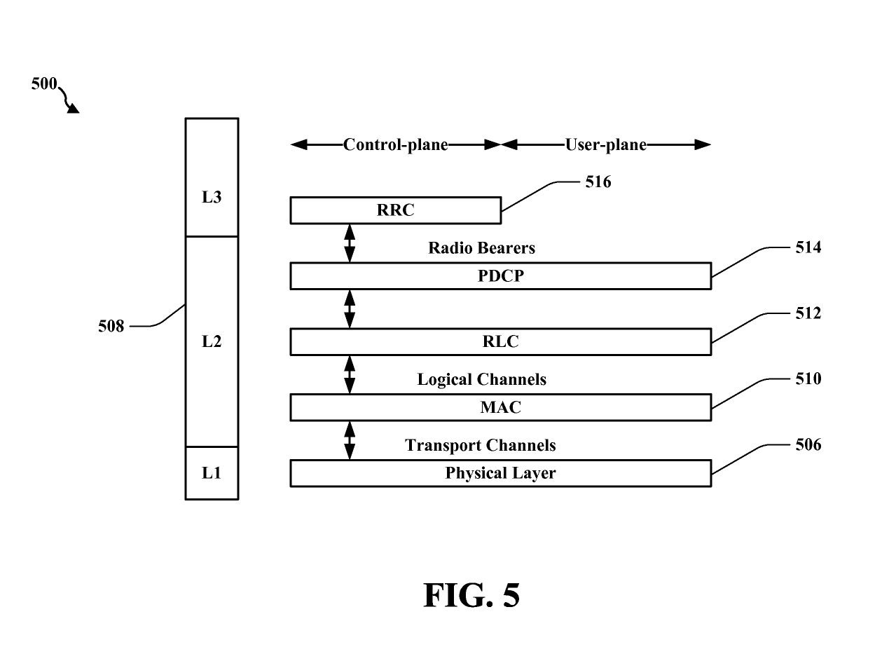

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

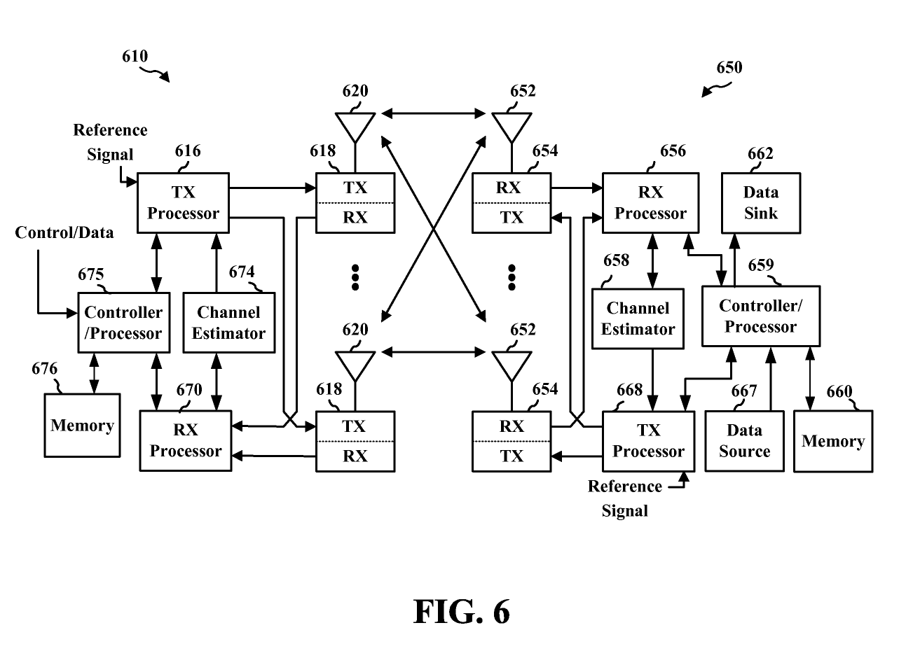

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

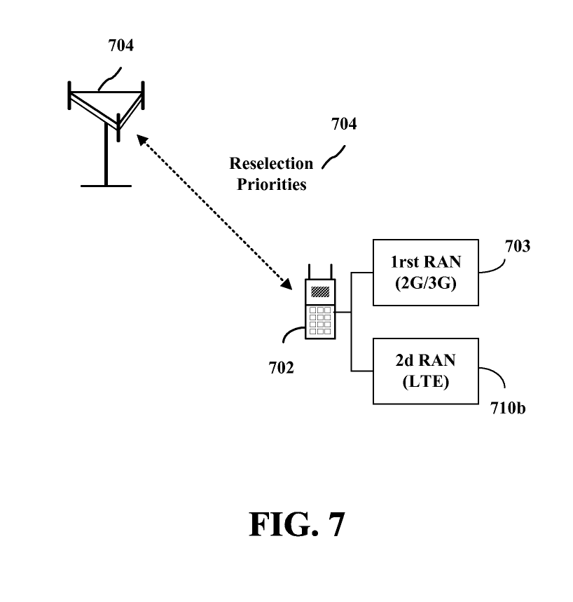

Certain operational characteristics, policies and procedures to be followed by UE connected to a RAN may be specified by a network operator. The operational characteristics, policies and procedures are typically communicated to the UE in SIBs. The operator may specify mobility procedures that govern network reselections, handover, and access preferences. A network operator may set priorities for cell acquisition that determine the priorities of supported RATs accessible by the UE. FIG. 7 illustrates a UE 702 receiving broadcast system information 704 including reselection priorities from a network 704. For example, a network operator may set priorities that cause a UE to camp on a preferred network when the UE is idle. In many instances, LTE is the preferred network for LTE-capable UE camping to enable the UE to avail of enhanced data services. However, the UE may be required to fallback to a circuit-switched network to receive or make a call, and the fallback process may create delays in call placement or reception.

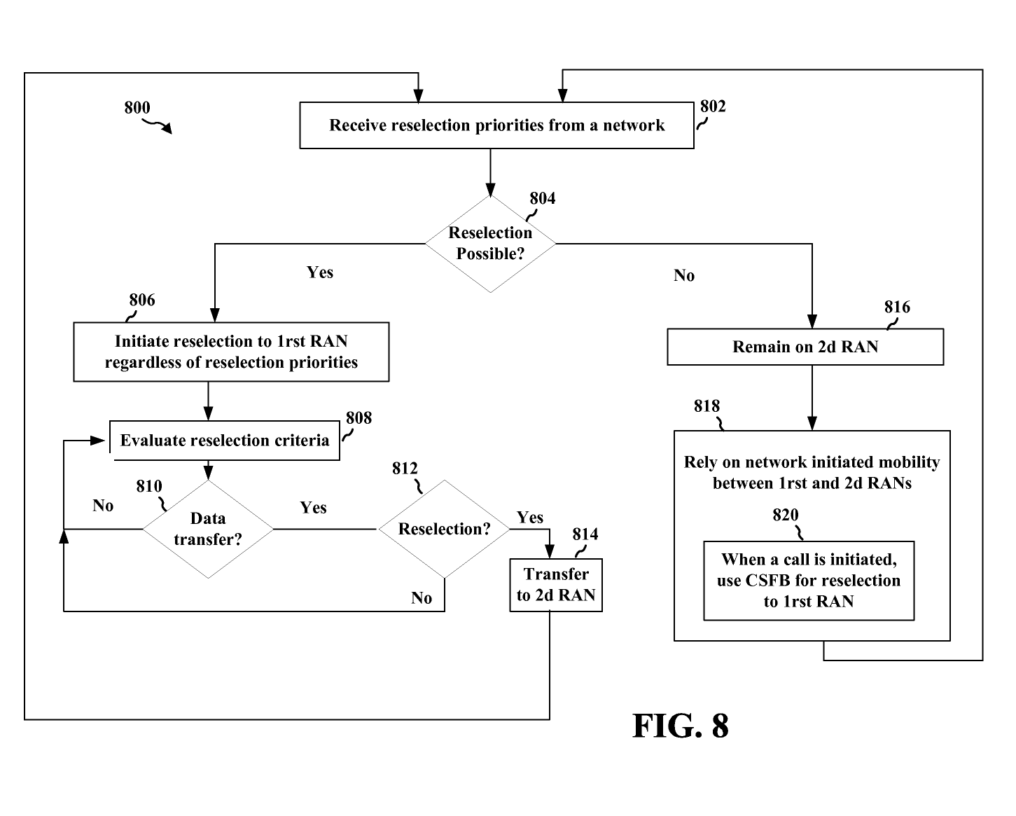

In order to address this problem, aspects implement a “2G/3G camping” strategy for an LTE-enabled UE, whereby the UE may override preferences and priorities broadcast to UEs in a RAN. FIG. 8 illustrates aspects of such a camping strategy. The UE receives reselection priorities from a network at 802. When reselection is possible, as determined at 804, the UE initiates reselection at 806 to a first RAN regardless of the reselection priorities received from the network. For example, in WCDMA, reselections can be performed in IDLE/CELL_PCH/URA_PCH/CELL_FACH states. In UMTS and LTE RANs, where network reselection priorities are broadcast in SIB19 and SIB6 respectively, the idle UE ignores the priorities in the SIBs and sets WCDMA as highest priority RAT. Therefore, when idle and camped in LTE, the UE may treat UMTS as a higher priority RAT and reselect UMTS where possible, even if LTE is specified as a higher priority by SIB6.

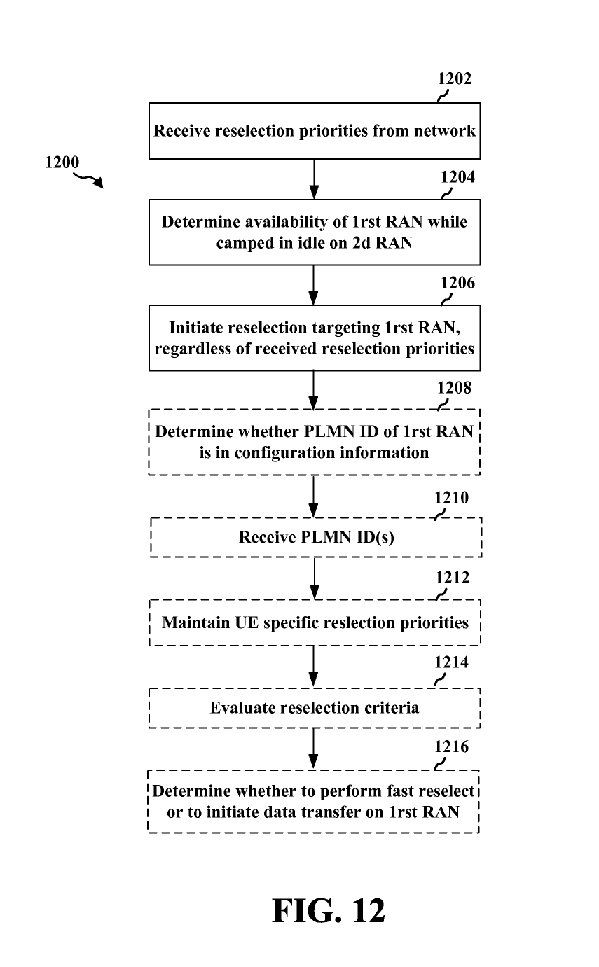

As described in further detail in connection with FIG. 12, when camped in UMTS, LTE cell reselection criteria may be evaluated periodically 808 according to the received selection priorities. Although the UE continues to evaluate whether to switch between UMTS and LTE according to reselection criteria, actual reselection may be postponed until a data transfer is initiated.

The UE always obeys dedicated reselection priorities, when received. For example, a reselection priority directed explicitly to the UE is obeyed, whereas a reselection priority broadcast to all UEs may be disregarded.

When it is determined that a data transfer is initiated at 810, the UE determines at 812 whether to perform fast reselection to the second RAN or whether to transfer the data via the first RAN. Potential aspects of this determination are described in further detail in connection with FIG. 12. When reselection criteria are not met, the UE remains on the first RAN and transfers the data. Then, the UE continues to evaluate reselection criteria at 808. However, when a reselection criterion is met, the UE transfers from the first RAN to the second RAN at 814 and transfers the data. Thereafter, the UE returns to 802.

When the UE is not idle, e.g., when in a connected active state on the second RAN, the UE remains on the second RAN at 816 and does not disregard the reselection priorities. While connected, the UE relies on network initiated mobility between the first and second RANs at 818. For example, when a call is initiated, the UE relies on CFSB for reselection to the first RAN 820.

By disregarding the reselection priorities broadcast from the network, the idle UE is provided with a UE centric mechanism that enables the UE to receive better call setup performance in idle mode without sacrificing the data transfer capabilities of 4G LTE, because the UE will move to 4G LTE as soon as a user initiates a data transfer.

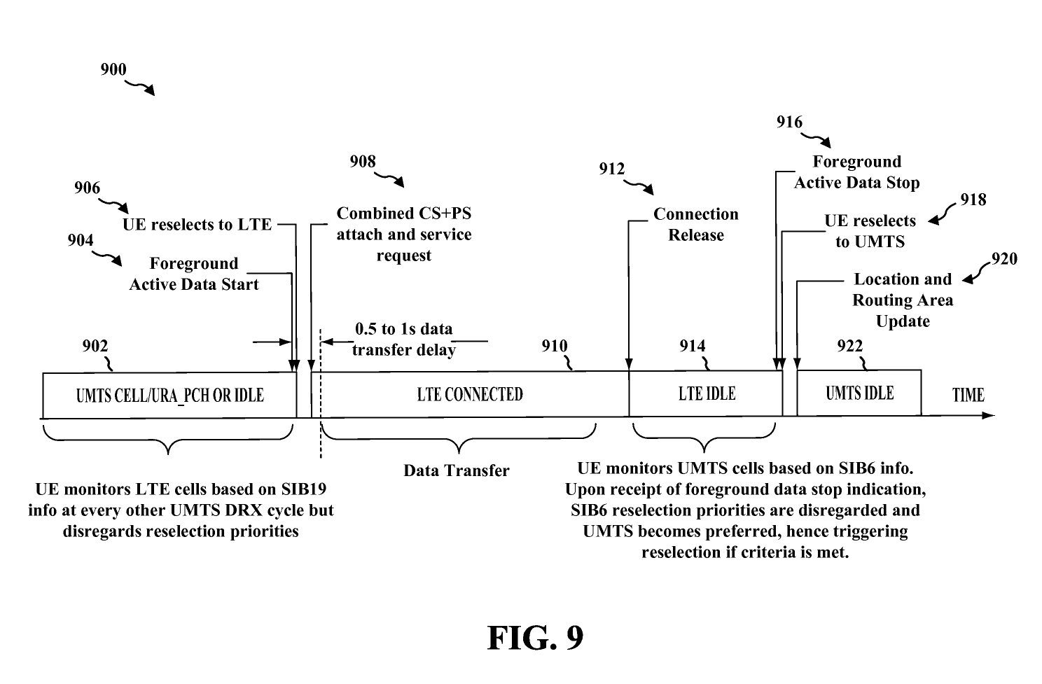

FIG. 9 illustrates a manner in which a UE can make a UMTS to LTE back to

UMTS transition using aspects disclosed herein. When the activity begins at 902, the UE may be in UMTS CELL/URA_PCH or IDLE mode. In this mode, the UE monitors LTE cells based on system provided criteria, e.g., SIB 19 information. This monitoring may occur, e.g., at every other UMTS DRX cycle in order to minimize the effect on idle power consumption caused by inter-RAT searches. As described in connection with FIGS. 7 and 8, in this mode, the UE disregards reselection priorities.

Upon initiation of a data transfer activity 904, such as a foreground active data start, the UE reselects to LTE 906. This action is followed shortly by the combined CS and packet signaling (PS) attachment and service request 908. Once this occurs, the UE is connected to the LTE network 910 and the data transfer begins. Prior to a data transfer activity, a 0.5 to 1 s data transfer delay occurs. The transition to the LTE network may be expedited by using Idle Mode Signaling Reduction (ISR), which avoids excessive signaling. This signals the initiation of foreground active data transfer activities.

Data transfer continues until a connection release 912, e.g., until idleModeMobilityControl/Info is provided in the release message. This signals that the data transfer is complete and that the connection may be released. At this stage the UE enters the LTE IDLE mode 914. While in the LTE IDLE mode, the UE monitors the UMTS cells, e.g., based on SIB6 information. Upon receipt of a foreground data stop indication, system reselection priorities are disregarded and UMTS becomes the preferred radio access technology. This triggers reselection if the system specified criteria are met.

The signal that LTE IDLE mode is complete may be, e.g., a foreground active data stop 916. It may be assumed that the user interface layer waits for the timer to expire after the foreground data application is closed before sending an indication to the modem layer. This may be implemented differently, depending on manufacturer preferences.

Once the LTE IDLE state is completed, the UE reselects to a UMTS network 918. A location and routing area update may be received 920. At that point, the UE may enter the UMTS IDLE state 922.

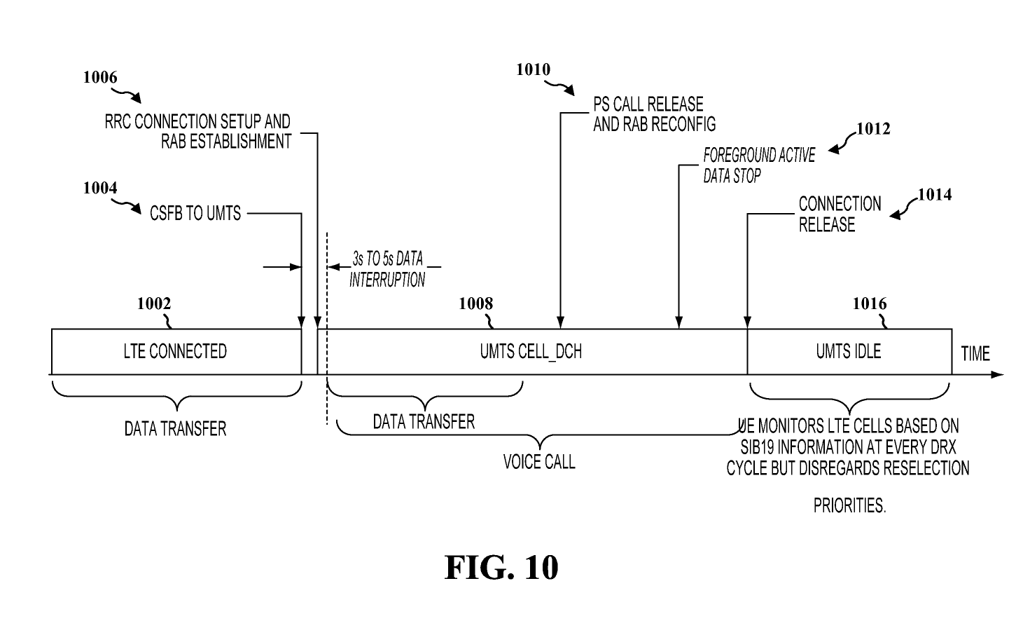

FIG. 10 illustrates a manner in which a UE uses CSFB in the connected state, when the foreground data activity stops before a voice call is released. At the start of the activity, the UE is in an LTE connected state 1002 and data transfer is occurring. The CSFB then begins to transition to UMTS 1004. At 1006, radio resource control (RRC) connection setup and radio access bearer (RAB) establishment occur. The transition to UMTS begins a 3 to 5 second data interruption period. At 1008, the UE is in UMTS mode, e.g., UMTS CELL_DCH mode. The data transfer may continue during the UMTS CELL_DCH state. At the start of the UMTS CELL_DCH period the voice call continues. During the UMTS CELL_DCH period the PS call release and RAB reconfiguration 1010 occur.

Once the data transfer is complete, the foreground data activity concludes 1012 and the connection is released 1014 after the foreground data activity stops. At this point, the UE enters the UMTS IDLE state 1016. During the UMTS IDLE state the UE monitors the LTE cells based on system information at every DRX cycle, but disregards the reselection priorities.

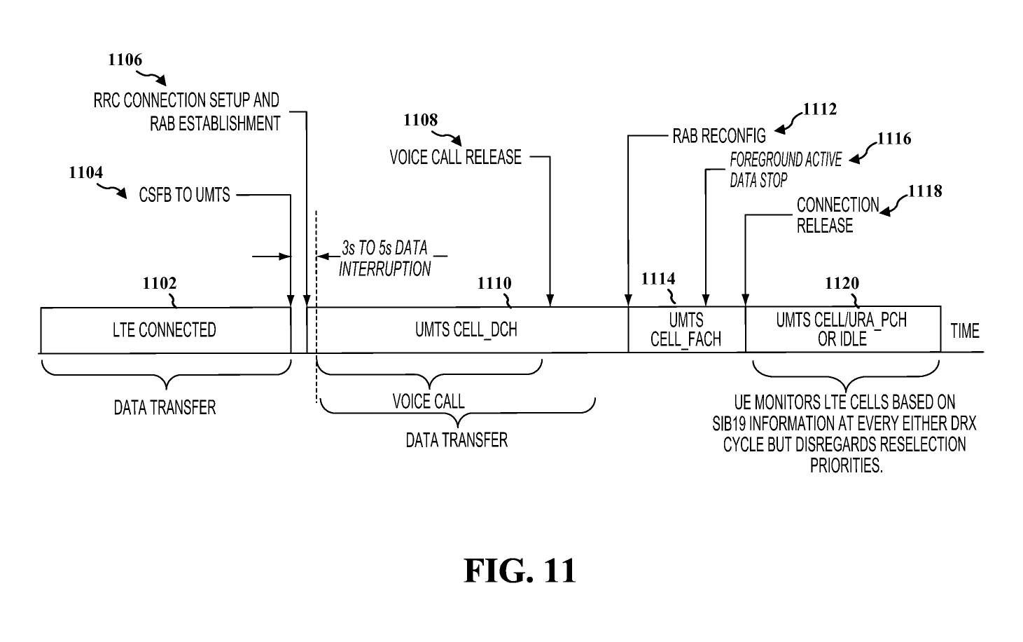

FIG. 11 illustrates aspects of the UE operations with CSFB in the connected state. In this embodiment, the voice call is released before the foreground data activity stops. At 1102, the UE is in LTE connected mode and data transfer is ongoing. When a call is initiated, the UE begins to transition to UMTS from the CSFB state 1104. There is, e.g., a 3-5 second data interruption. RRC Connection set up and RAB establishment 1106 occur.

The UE begins a voice call, while in the network connected state 1110, e.g., UMTS CELL_DCH. While in the network connected state the voice call and the data transfer occur. The voice call is released at 1108, and the data transfer may continue. RAB reconfiguration 1112 then takes place and the UE transitions to the network connected state 1114, e.g., UMTS CELL_FACH. While in the network connected state, the foreground active data stops 1116. This stop occurs, e.g., when a foreground data stop indication is received. Upon receipt of the foreground data stop indication, UMTS is set as the highest priority radio access technology. However, reselection to LTE does not occur because the UE is not able to perform LTE measurements when in the CELL_FACH connected state.

A connection release 1118 is received after the foreground data stop indication and upon receipt the UE transitions to the idle state 1120 (UMTS CELL/URA_PCH or IDLE state). While in the idle state the UE may monitor LTE cells based on the system information broadcast information, e.g., at every other DRX cycle. However, the UE disregards the reselection priorities in order to camp on UMTS.

FIG. 12 illustrates a flow chart of a method of wireless communication. The method may be performed by a UE. At 1202, the UE receives broadcast system information including one or more reselection priorities defined by a network operator for UE operation. At 1204, the UE determines the availability of a first RAN operated using a first RAT while camped in idle mode on a second RAN using a second RAT. The first RAN may comprise a lower data rate network than the second RAN. For example, the first RAN may comprise a 2G/3G network and the second RAN may comprise a 4G/LTE network. In UMTS and LTE, the UE may receive priorities that cause the UE to camp on a preferred network when the UE is idle, e.g., via SIB19 and SIB6 messages, respectively. At 1206, the UE initiates a reselection procedure targeting the first RAN regardless of the reselection priorities, wherein each of the reselection priorities identifies a priority for one or more of a RAT and a RAN. For example, in UMTS and LTE, the UE disregards the received SIB 19 and SIB6 reselection priorities, respectively. Instead, the UE sets WCDMA as the highest priority RAT.

The camping feature described herein may be enabled or disabled based on configuration information maintained at the UE. For example, a non-volatile storage of the UE may be configured with a list of public land mobile network (PLMN) identifiers (IDs) that enable the 2G/3G camping feature. The feature may be activated when the UE camps in a network corresponding to any PLMN ID in the UE configuration. Thus, at 1208, the UE may optionally determine whether a PLMN ID of the first RAN is identified in configuration information of the UE. The step of initiating reselection procedure targeting the first RAN regardless of the reselection priorities may then performed when the PLMN ID is identified in the configuration information

The listing of PLMN IDs maintained by the UE may be configured over the air. Thus, at 1210, the UE may receive one or more PLMN IDs. The step of initiating reselection procedure targeting the first RAN regardless of the reselection priorities may then be performed when the first RAN is associated with one of the one or more PLMN IDs.

A UE obeys dedicated reselection priorities, if received. For example, a reselection priority directed explicitly to the UE is obeyed, whereas a reselection priority broadcast to all UEs may be disregarded. For example, at 1212, the UE may maintain system information that includes at least one UE-specific reselection priority, wherein the step of initiating reselection procedure targeting the first RAN regardless of the reselection priorities is not performed when the at least one UE-specific reselection priority is maintained by the UE. The at least one UE-specific reselection priority may be received, e.g., in non-broadcast system information.

When camped in the first RAN, cell reselection criteria may be evaluated periodically taking into account the received reselection priorities. For example, at 1214, the UE may evaluate reselection criteria for reselection from the first RAN to the second RAN, while camped on the first RAN. For example, while camped in 2G/3G, the UE may continue evaluating 2G/3G to LTE reselection criteria. However, the UE may postpone the actual reselection until a data transfer is initiated. For example, a flag may be set in memory when criteria are met. Such a flag may be cleared when criteria are not met. Additionally, when reselection criteria are met, e.g., for reselection from the first RAN to the second RAN, an indication may be presented at the UE. For example, when LTE reselection criteria are satisfied, a 4G LTE indicator may be displayed to a user.

As noted, the UE may evaluate reselection criteria, but postpone actual reselection until a data transfer is initiated. When a data transfer is initiated while camped on the first RAN and the reselection criteria are met, the UE may perform a fast reselection to the second RAN and transfer the data via the second RAN. For example, in a UMTS IDLE or URA/CELL_PCH state, if LTE cell reselection criteria are met, e.g., a corresponding flag has been set in memory, and a data application is started in the foreground, the UE may move immediately to LTE to establish a connection, similar to the transfer in FIG. 9.

When a data transfer is initiated while camped on the first RAN and the reselection criteria are not met, the UE may initiate the data transfer on the first RAN. Thus, when a data transfer is initiated while camped on the first RAN, the UE may determine at 1216 whether to perform a fast reselection to the second RAN or to initiate the data transfer on the first RAN. The determination may based on any of the size of data to be transmitted, a nature of the data to be transmitted, a current buffer capacity, an anticipated buffer capacity, and availability of network services through the current RAT.

The determination may be based, e.g., on a nature of the data to be transmitted, wherein the criteria includes whether the data transfer is a foreground data transfer or a background data transfer. Background activity is data activity occurring without visibility to the user. The determination of the type of data activity may be based on information from an application or operating system on the type of data activity. Aspects may include, an application programming interface (API) provided by the wireless modem may enable a user interface (UI) layer to send indications regarding foreground data applications status. An OEM may configure that UI layer logic to use the API. Thus, the specific upper layer logic user for the API may vary with each equipment manufacturer. The determination of the type of data activity may also be based on information from the system as to whether the display of the UE is on or off. The determination of the type of data activity may also be based on information from the system as to whether the data request was based on user interaction or not. This may include a determination as to whether the UE received a recent keypress or sensor input.

In a connected mode, the UE may still rely on network initiated mobility between the first and second RANs. When in an UMTS CELL_DCH or CELL_FACH state, the UE relies on network initiated procedures for mobility and steering traffic across RATs. For example, the UE will continue to rely on CSFB if the user initiates a call while on LTE with a data transfer ongoing, as illustrated in FIG. 10.

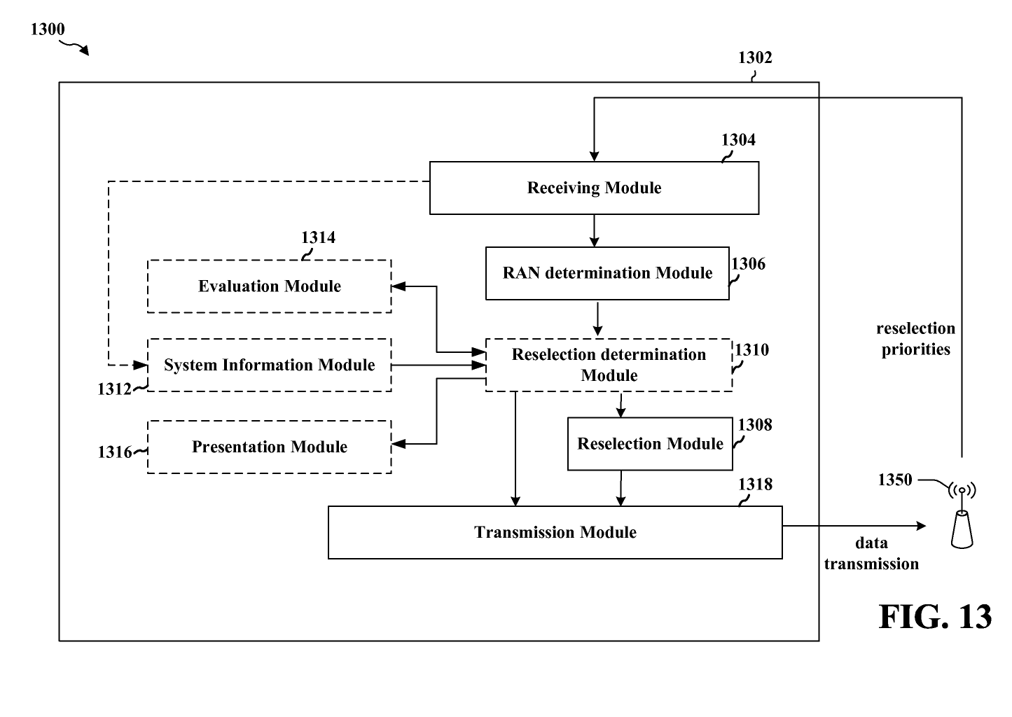

FIG. 13 is a conceptual data flow diagram 1300 illustrating the data flow between different modules/means/components in an exemplary apparatus 1302. The apparatus may be a UE. The apparatus includes a receiving module 1304 that receives broadcast system information including one or more reselection priorities defined by a network operator 1350 for UE operation, a RAN determination module 1306 that determines the availability of a first RAN operated using a first RAT while camped in idle mode on a second RAN using a second RAT, and a module 1308 that initiates a reselection procedure targeting the first RAN regardless of the reselection priorities, each of the reselection priorities identifying a priority for one or more of a RAT and a RAN. The first RAN may comprise a lower data rate network, e.g., 2G/3G, than the second RAN, e.g., 4G LTE.

The apparatus may further include a reselection determination module 1310 that determines whether to initiate reselection based on whether a PLMN ID of the first RAN is identified in configuration information of the UE, as described in connection with FIG. 12. The PLMN IDs may be received via the receiving module 1304.

The apparatus may further include a system information module 1312 that maintains, at the UE, system information that includes at least one UE-specific reselection priority. The UE-specific reselection priority may be received, e.g., in non-broadcasted system information, via the receiving module 1304 and provided to the reselection determination module 1310.

The apparatus may further include an evaluation module 1314 that periodically evaluates reselection criteria for reselection from the first RAN to the second RAN, while camped on the first RAN. Such an evaluation is described in further detail in connection with FIG. 12. The apparatus may include a presentation module 1316 that presents an indication at the UE, when a reselection criterion is met for reselection from the first RAN to the second RAN.

The reselection module 1308 may perform a fast reselection to the second RAN, when a data transfer is initiated while camped on the first RAN and the reselection criterion is met. The apparatus may further include a transmission module 1318 that transfers the data via the currently selected RAN. For example, after fast reselection to the second RAN, the transmission module 1318 may transfer the data via the second RAN. When a data transfer is initiated while camped on the first RAN and the reselection criterion is not met, the transmission module 1318 may initiate the data transfer on the first RAN.

The reselection determination module 1310 may determine whether to perform a fast reselection to the second RAN or to initiate the data transfer on the first RAN, when a data transfer is initiated while camped on the first RAN. The determination may be based on at least one of size of data to be transmitted, a nature of the data to be transmitted, a current buffer capacity, an anticipated buffer capacity, and availability of network services through the current RAT. For example, the determination may be based on a nature of the data to be transmitted, wherein the criteria includes whether the data transfer is a foreground data transfer or a background data transfer.

The apparatus may include additional modules that perform each of the steps of the algorithm in the aforementioned flow charts of FIGS. 8 and 12. As such, each step in the aforementioned flow charts of FIGS. 8 and 12 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

FIG. 13 is a diagram 1300 illustrating an example of a hardware implementation for an apparatus 1302′ employing a processing system 1414. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware modules, represented by the processor 1404, the modules 1304, 1306, 1308, 1310, 1312, 1314, 1316, and 1318, and the computer-readable medium 1406. The bus 1424 may also link various other circuits such as timing sources, peripherals, voltage regulators, and power management circuits, which are well known in the art, and therefore, will not be described any further.

The processing system 1414 may be coupled to a transceiver 1410. The transceiver 1410 is coupled to one or more antennas 1420. The transceiver 1410 provides a means for communicating with various other apparatus over a transmission medium. The processing system 1414 includes a processor 1404 coupled to a computer-readable medium 1406. The processor 1404 is responsible for general processing, including the execution of software stored on the computer-readable medium 1406. The software, when executed by the processor 1404, causes the processing system 1414 to perform the various functions described supra for any particular apparatus. The computer-readable medium 1406 may also be used for storing data that is manipulated by the processor 1404 when executing software. The processing system further includes at least one of the modules 1304, 1306, 1308, 1310, 1312, 1314, 1316, and 1318. The modules may be software modules running in the processor 1404, resident/stored in the computer readable medium 1406, one or more hardware modules coupled to the processor 1404, or some combination thereof. The processing system 1414 may be a component of the UE 650 and may include the memory 660 and/or at least one of the TX processor 668, the RX processor 656, and the controller/processor 659.

In one configuration, the apparatus 1302/1302′ for wireless communication includes means for means for receiving at a UE, broadcast system information including one or more reselection priorities defined by a network operator for UE operation; means for determining availability of a first RAN operated using a first RAT while camped in idle mode on a second RAN using a second RAT; and means for initiating a reselection procedure targeting the first RAN regardless of the reselection priorities, wherein each of the reselection priorities identifies a priority for one or more of a RAT and a RAN. The apparatus 1302/1302′ may further include means for determining to initiate reselection, that determine whether a PLMN ID of the first RAN is identified in configuration information of the UE, wherein the means for initiating reselection target the first RAN regardless of the reselection priorities is performed when the PLMN ID is identified in the configuration information. The means for receiving may further receive one or more PLMN IDs, and the means for initiating reselection target the first RAN regardless of the reselection priorities may be performed when the first RAN is associated with one of the one or more PLMN IDs. The apparatus may further include means for maintaining at the UE, system information that includes at least one UE-specific reselection priority, wherein the means for initiating reselection procedure target the first RAN regardless of the reselection priorities is not performed when the at least one UE-specific reselection priority is maintained by the UE.

The apparatus may further include means for evaluating reselection criteria for reselection from the first RAN to the second RAN, while camped on the first RAN and means for presenting an indication at the UE, when reselection criterion is met for reselection from the first RAN to the second RAN.

The means for initiating reselection may perform a fast reselection to the second RAN, when a data transfer is initiated while camped on the first RAN and the reselection criterion is met, and the apparatus may further include means for transferring the data via the second RAN.

The apparatus may further include means for initiating the data transfer on the first RAN, when a data transfer is initiated while camped on the first RAN and the reselection criteria is not met.

The apparatus may further include means for determining whether to perform a fast reselection to the second RAN or to initiate the data transfer on the first RAN, when a data transfer is initiated while camped on the first RAN.

The aforementioned means may be one or more of the aforementioned modules of the apparatus 1302 and/or the processing system 1414 of the apparatus 1302′ configured to perform the functions recited by the aforementioned means. As described supra, the processing system 1414 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
receiving at a user equipment (UE), broadcast system information including one or more reselection priorities defined by a network operator for UE operation;
determining availability of a first radio access network (RAN) operated using a first radio access technology (RAT) while camped in idle mode on a second RAN using a second RAT; and
initiating a reselection procedure targeting the first RAN regardless of the reselection priorities,
wherein each of the reselection priorities identifies a priority for one or more of a RAT and a RAN.

2. The method of claim 1, wherein the first RAN comprises a lower data rate network than the second RAN.

3. The method of claim 2, wherein the first RAN comprises one of a 2G network and a 3G network.

4. The method of claim 3, wherein the second RAN comprises one of a 4G network and a Long Term Evolution (LTE) network.

5. The method of claim 1, further comprising:
determining whether a PLMN ID of the first RAN is identified in configuration information of the UE,
wherein initiation of the reselection procedure targeting the first RAN regardless of the reselection priorities is performed when the PLMN ID is identified in the configuration information.

6. The method of claim 1, further comprising:
receiving one or more public land mobile network (PLMN) identifiers (IDs),
wherein initiation of the reselection procedure targeting the first RAN regardless of the reselection priorities is performed when the first RAN is associated with one of the one or more PLMN IDs.

7. The method of claim 1, further comprising:
maintaining at the UE, system information that includes at least one UE-specific reselection priority, wherein initiation of the reselection procedure targeting the first RAN regardless of the reselection priorities is not performed when the at least one UE-specific reselection priority is maintained by the UE.

8. The method of claim 7, wherein the at least one UE-specific reselection priority is received in non-broadcast system information.

9. The method of claim 1, further comprising:
evaluating reselection criteria for reselection from the first RAN to the second RAN, while camped on the first RAN.

10. The method of claim 9, further comprising:
when reselection criteria is met for reselection from the first RAN to the second RAN, presenting an indication at the UE.

11. The method of claim 9, further comprising:
when a data transfer is initiated while camped on the first RAN and the reselection criteria is met, performing a fast reselection to the second RAN; and
transferring the data via the second RAN.

12. The method of claim 9, further comprising:
when a data transfer is initiated while camped on the first RAN and the reselection criteria is not met, initiating the data transfer on the first RAN.

13. The method of claim 9, further comprising:
when a data transfer is initiated while camped on the first RAN, determining whether to perform a fast reselection to the second RAN or to initiate the data transfer on the first RAN.

14. The method of claim 13, wherein the determination is based on at least one of a size of the data to be transmitted, a nature of the data to be transmitted, a current buffer capacity, an anticipated buffer capacity, and availability of network services through the current RAT.

15. The method of claim 14, wherein the determination is based on a nature of the data to be transmitted, and wherein the criteria includes whether the data transfer is a foreground data transfer or a background data transfer.

16. An apparatus for wireless communication, comprising:
means for receiving at a user equipment (UE), broadcast system information including one or more reselection priorities defined by a network operator for UE operation;
means for determining availability of a first radio access network (RAN) operated using a first radio access technology (RAT) while camped in idle mode on a second RAN using a second RAT; and
means for initiating a reselection procedure targeting the first RAN regardless of the reselection priorities,
wherein each of the reselection priorities identifies a priority for one or more of a RAT and a RAN.

17. The apparatus of claim 16, wherein the first RAN comprises a lower data rate network than the second RAN.

18. The apparatus of claim 17, wherein the first RAN comprises one of a 2G network and a 3G network.

19. The apparatus of claim 18, wherein the second RAN comprises one of a 4G network and a Long Term Evolution (LTE) network.

20. The apparatus of claim 16, further comprising means for determining whether to initiate reselection based on whether a PLMN ID of the first RAN is identified in configuration information of the UE,
wherein the means for initiating reselection perform reselection targeting the first RAN regardless of the reselection priorities when the PLMN ID is identified in the configuration information.

21. The apparatus of claim 16, wherein the means for receiving further receive one or more public land mobile network (PLMN) identifiers (IDs), and
wherein the means for initiating reselection perform reselection targeting the first RAN regardless of the reselection priorities when the first RAN is associated with one of the one or more PLMN IDs.

22. The apparatus of claim 16, further comprising:
means for maintaining at the UE, system information that includes at least one UE-specific reselection priority, wherein the means for initiating the reselection procedure do not perform reselection targeting the first RAN regardless of the reselection priorities when the at least one UE-specific reselection priority is maintained by the UE.

23. The apparatus of claim 22, wherein the at least one UE-specific reselection priority is received in non-broadcast system information.

24. The apparatus of claim 16, further comprising:
means for evaluating reselection criteria for reselection from the first RAN to the second RAN, while camped on the first RAN.

25. The apparatus of claim 24, further comprising
means for presenting an indication at the UE, when a reselection criterion is met for reselection from the first RAN to the second RAN.

26. The apparatus of claim 24, wherein the means for initiating reselection perform a fast reselection to the second RAN, when a data transfer is initiated while camped on the first RAN and the reselection criteria is met, the apparatus further comprising:
means for transferring the data via the second RAN.

27. The apparatus of claim 24, further comprising:
means for initiating the data transfer on the first RAN, when a data transfer is initiated while camped on the first RAN and the reselection criteria is not met.

28. The apparatus of claim 24, further comprising:
means for determining whether to perform a fast reselection to the second RAN or to initiate the data transfer on the first RAN, when a data transfer is initiated while camped on the first RAN.

29. The apparatus of claim 28, wherein the means for determining perform the determination based on at least one of a size of the data to be transmitted, a nature of the data to be transmitted, a current buffer capacity, an anticipated buffer capacity, and availability of network services through the current RAT.

30. The apparatus of claim 29, wherein the means for determining perform the determination based on a nature of the data to be transmitted, wherein the criteria includes whether the data transfer is a foreground data transfer or a background data transfer.

31. An apparatus for wireless communication, comprising:
a processing system configured to:
receive at a user equipment (UE), broadcast system information including one or more reselection priorities defined by a network operator for UE operation;
determine availability of a first radio access network (RAN) operated using a first radio access technology (RAT) while camped in idle mode on a second RAN using a second RAT; and
initiate a reselection procedure targeting the first RAN regardless of the reselection priorities,
wherein each of the reselection priorities identifies a priority for one or more of a RAT and a RAN.

32. The apparatus of claim 31, wherein the first RAN comprises a lower data rate network than the second RAN.

33. The apparatus of claim 32, wherein the first RAN comprises one of a 2G network and a 3G network.

34. The apparatus of claim 33, wherein the second RAN comprises one of a 4G network and a Long Term Evolution (LTE) network.

35. The apparatus of claim 31, wherein the processing system is further configured to:
determine whether a PLMN ID of the first RAN is identified in configuration information of the UE,
wherein initiation of the reselection procedure targeting the first RAN regardless of the reselection priorities is performed when the PLMN ID is identified in the configuration information.

36. The apparatus of claim 31, wherein the processing system is further configured to:
receive one or more public land mobile network (PLMN) identifiers (IDs),
wherein initiation of the reselection procedure targeting the first RAN regardless of the reselection priorities is performed when the first RAN is associated with one of the one or more PLMN IDs.

37. The apparatus of claim 31, wherein the processing system is further configured to:
maintain at the UE, system information that includes at least one UE-specific reselection priority, wherein initiation of the reselection procedure targeting the first RAN regardless of the reselection priorities is not performed when the at least one UE-specific reselection priority is maintained by the UE.

38. The apparatus of claim 37, wherein the at least one UE-specific reselection priority is received in non-broadcast system information.

39. The apparatus of claim 31, wherein the processing system is further configured to:
evaluate reselection criteria for reselection from the first RAN to the second RAN, while camped on the first RAN.

40. The apparatus of claim 39, wherein the processing system is further configured to:
present an indication at the UE, when the reselection criterion is met for reselection from the first RAN to the second RAN.

41. The apparatus of claim 39, wherein the processing system is further configured to:
perform a fast reselection to the second RAN, when a data transfer is initiated while camped on the first RAN and the reselection criteria is met; and
transfer the data via the second RAN.

42. The apparatus of claim 39, wherein the processing system is further configured to:
initiate the data transfer on the first RAN, when a data transfer is initiated while camped on the first RAN and the reselection criteria is not met.

43. The apparatus of claim 39, wherein the processing system is further configured to:
determine whether to perform a fast reselection to the second RAN or to initiate the data transfer on the first RAN, when a data transfer is initiated while camped on the first RAN.

44. The apparatus of claim 43, wherein the determination is based on at least one of a size of the data to be transmitted, a nature of the data to be transmitted, a current buffer capacity, an anticipated buffer capacity, and availability of network services through the current RAT.

45. The apparatus of claim 44, wherein the determination is based on a nature of the data to be transmitted, wherein the criteria includes whether the data transfer is a foreground data transfer or a background data transfer.

46. A computer program product, comprising:
a computer-readable medium comprising code for:
receiving at a user equipment (UE), broadcast system information including one or more reselection priorities defined by a network operator for UE operation;
determining availability of a first radio access network (RAN) operated using a first radio access technology (RAT) while camped in idle mode on a second RAN using a second RAT; and
initiating a reselection procedure targeting the first RAN regardless of the reselection priorities,
wherein each of the reselection priorities identifies a priority for one or more of a RAT and a RAN.

47. The computer program product of claim 46, wherein the first RAN comprises a lower data rate network than the second RAN.

48. The computer program product of claim 47, wherein the first RAN comprises one of a 2G network and a 3G network.

49. The computer program product of claim 48, wherein the second RAN comprises one of a 4G network and a Long Term Evolution (LTE) network.

50. The computer program product of claim 46, further comprising code for:
determining whether a PLMN ID of the first RAN is identified in configuration information of the UE,
wherein initiation of the reselection procedure targeting the first RAN regardless of the reselection priorities is performed when the PLMN ID is identified in the configuration information.

51. The computer program product of claim 46, further comprising code for:
receiving one or more public land mobile network (PLMN) identifiers (IDs),
wherein initiation of the reselection procedure targeting the first RAN regardless of the reselection priorities is performed when the first RAN is associated with one of the one or more PLMN IDs.

52. The computer program product of claim 46, further comprising code for:
maintaining at the UE, system information that includes at least one UE-specific reselection priority, wherein initiation of the reselection procedure targeting the first RAN regardless of the reselection priorities is not performed when the at least one UE-specific reselection priority is maintained by the UE.

53. The computer program product of claim 52, wherein the at least one UE-specific reselection priority is received in non-broadcast system information.

54. The computer program product of claim 46, further comprising code for:
evaluating reselection criteria for reselection from the first RAN to the second RAN, while camped on the first RAN.

55. The computer program product of claim 54, further comprising code for:
presenting an indication at the UE, when the reselection criterion is met for reselection from the first RAN to the second RAN.

56. The computer program product of claim 54, further comprising code for:
performing a fast reselection to the second RAN, when a data transfer is initiated while camped on the first RAN and the reselection criteria is met; and
transferring the data via the second RAN.

57. The computer program product of claim 54, further comprising:
when a data transfer is initiated while camped on the first RAN and the reselection criteria is not met, initiating the data transfer on the first RAN.

58. The computer program product of claim 54, further comprising code for:
determining whether to perform a fast reselection to the second RAN or to initiate the data transfer on the first RAN, when a data transfer is initiated while camped on the first RAN.

59. The computer program product of claim 58, wherein the determination is based on at least one of a size of the data to be transmitted, a nature of the data to be transmitted, a current buffer capacity, an anticipated buffer capacity, and availability of network services through the current RAT.

60. The computer program product of claim 59, wherein the determination is based on a nature of the data to be transmitted, wherein the criteria includes whether the data transfer is a foreground data transfer or a background data transfer.
